(19) United States
(12) Patent Application Publication
(10) Pub. No.: US 2012/0146395 A1
(43) Pub. Date: Jun. 14, 2012

(54) WHEEL OF POLYMERIC MATERIAL

(76) Inventors: José Donizeti da Silva, Jundiai-SP (BR); Marcio Tiraboschi, Jundiai-SP (BR)

(21) Appl. No.: 13/381,408

(22) PCT Filed: Jun. 29, 2010
(86) PCT No.: PCT/BR2010/000220

§ 371 Date: Feb. 28, 2012

(30) Foreign Application Priority Data
Jul. 2, 2009 (BR) PI 0902289-9

(51) Int. Cl. B60B 5/02

(52) U.S. Cl. 301/64.702

(57) ABSTRACT

The present wheel comprises a body (C) formed by a median disc (10) provided with a central hole (11), to be mounted to a shaft end of a vehicle, and a plurality of eccentric holes (12) for the passage of fixing bolts; and by a peripheral ring (20) configured to retain a vehicle tire, said wheel having its body (C) injected, in a single piece, in a polymeric composite material comprising, in a homogeneous mixture, from 40% to 70% of a thermoplastic polymeric matrix, from 30% to 60% of synthetic fibers and from 0.01% to 10% of additives.

### FIELD OF THE INVENTION

The present invention refers to a new construction for a tire wheel to be applied to several vehicles, such as cars, light and heavy utility vehicles, motorcycles, tricycles, quadricycles, vehicles for internal transportation of load and people, agricultural vehicles, and vehicles for other applications, said wheel being constructed in a thermoplastic composite material.

### BACKGROUND OF THE INVENTION

As known in the prior art, the polymeric composite materials are those in which two or more materials are associated so as to attain a synergy of properties and performance optimization and, accordingly, to obtain characteristics that are superior to those of the unitary materials. Composite materials usually result from the association of a polymeric base with one or more reinforcing materials.

In industry, there is a remarkable demand for products which provide weight reduction, allied to property improvements, performance optimization and differentiated visual aspect provided by design freedom. Apart from these aspects, it is expected productivity increase, quality improvement, ecological appeal due to recyclability, comfort, safety, autonomy improvement, reduction of pollutant emissions, and the like.

The lightweight alloy wheels are manufactured in a cast single piece and the steel wheels are made of stamped rim and disc, requiring welding spots in which oxidation points may arise, impairing the durability and the safety of the product. Another aspect to be considered is the fact that the metallic materials have a higher specific weight than the polymeric materials, implying a larger mass for the wheel manufactured with such materials and, accordingly, a heavier vehicle and higher consumption of energy and/or fuel.

Besides the inconveniences above, these known wheels may present permanent deformation (plastic deformation) in case of impacts, causing serious or even permanent damages to the product and to the system associated therewith. Specifically, the process of casting the lightweight alloy wheels enhances the potential for failure due to the presence of porosity in the material, which is difficult to control and inherent to the manufacturing process. The subsequent machining step is a costly and lengthy process which generates many oil residues and waste metal. Moreover, upon analyzing the whole productive cycle of the wheel, there is a high consumption of electric energy, water and other inputs inherent to the casting process.

Attempts have been made to produce wheels in polymers reinforced with glass fibers through several processes and often using thermoset materials (not recyclable), which attempts failed in the validation tests or considered commercially unfeasible.

A prior art example is described in Patent U.S. Pat. No. 4,900,097, which uses a disc inserted between the fixing bolts and the braking system, with the purpose of dissipating heat. In this construction, the disc may separate from the plastic rim.

Patent U.S. Pat. No. 3,811,737 suggests using metal plates to avoid the bolts from being excessively tightened in the resin that has low resistance to compression.

Patent U.S. Pat. No. 3,917,352 presents several continuous glass fiber filaments to reinforce the plastic structure, but the manufacturing process is expensive and crafty, making the final product economically unfeasible or poorly competitive.

In patent U.S. Pat. No. 4,072,358, the wheel is molded in a process of compressing Polyamide (PI) sheets with cut glass fibers.

Patent U.S. Pat. No. 5,826,948 presents a wheel produced in two pieces that are bonded to each other, requiring two injection molds, which raises the production cost.

Patent U.S. Pat. No. 5,268,139 discloses a design to avoid the knit lines of different polymer flow lines in weaker regions, which is a great limitation to the design freedom of the wheel and to the adaptation of its plastic form to each design requirement.

The known vehicular wheels formed in plastic material are generally obtained from polymeric materials whose composition presents deficiencies regarding its structural resistance, resistance to weather conditions, aging, capability of withstanding great tightening and retaining forces in the shaft ends in which the wheels are mounted, and also concerning the complexity in manufacturing and adapting its structural design to the aesthetic and functional requirements in each application.

### SUMMARY OF THE INVENTION

In face of the deficiencies presented by the vehicular wheels for pneumatic tires known so far, it is an object of the present invention to provide a wheel in polymeric material, which is relatively simple to manufacture and has a high design flexibility, further presenting high resistance to tension, compression, bending and impact, and guaranteeing a long useful life even when submitted to weather conditions and chemical attacks during its use in a vehicle.

These positive properties are obtained with the wheel proposed herein, which is of the type comprising a body formed: by a median disc provided with a central hole, to be mounted in a shaft end of a vehicle, and a plurality of eccentric holes for the passage of fixing bolts; and by a peripheral ring configured to retain a vehicle tire. The wheel considered herein is injected, in a single piece, from a novel polymeric composition which comprises, in a homogeneous mixture, from 40% to 70% of a thermoplastic polymeric matrix, preferably a polyamide (PA), from 30% to 60% of synthetic fibers and from 0.01% to 10% of additives.

Besides the structural and functional characteristics of the novel wheel, it should be understood that the manufacture of the wheel body by injection allows reducing the production cycle, reducing costs and making the product economically feasible.

The development of the product, both in aesthetic (design) and functional terms, is allied to computational simulations, such as structural analysis, fatigue and conformation, by using softwares for Finite Element Analysis (FEA); interaction analysis between design/product/material/process and tooling; and simulations of physical bench tests, which accelerate the analysis of the product's performance, avoiding trial and error.

Such simulations reduce the time and the costs involved in the steps of conception, development and validation of the product. Finally, the laboratory and fatigue tests, associated with durability and field tests, allow homologating a product which complies with the specific application requirements. However, due to the lack of specific national and international rules and regulations for this type of product in polymeric composite material, the performance evaluation was conducted based on the SAE, ISO and NBR (Brazilian rule) specifications and regulations applied to the current products commonly manufactured in metal materials and their alloys.

Another important point is that the vehicles do not need to be modified to receive the wheel of the present invention.

### BRIEF DESCRIPTION OF THE DRAWINGS

The invention will be described below, with reference to the enclosed drawings, given by way of illustration of a possible embodiment for the present wheel and in which:

FIG. 1 represents a partially sectioned perspective view of a wheel construction deprived of inserts;

FIG. 2 represents a partially sectioned perspective view of a wheel construction provided with an insert, in a metallic alloy, affixed in the interior of the central hole of the median disc, so as to coat said central hole along its whole axial extension;

FIG. 3 represents a perspective view similar to that of FIG. 2, but illustrating the eccentric holes of the median disc internally coated, along the whole axial extension thereof, by an insert in metallic alloy;

FIG. 4 represents a perspective view similar to that of FIG. 3, but illustrating the eccentric holes of the median disc internally coated, in only part of their axial extension, by an insert;

FIG. 5 represents a perspective view similar to that of FIGS. 2 and 4, with the central hole internally coated in its whole axial extension, and with the eccentric holes internally coated in only part of their whole axial extension, by a respective insert in metallic alloy; and

FIG. 6 represents a perspective view similar to that of FIG. 5, but illustrating a construction in which the insert of the central hole and the inserts of the eccentric holes form a single piece, onto which it is injected the polymeric material that forms the wheel body.

### DESCRIPTION OF THE INVENTION

As already mentioned and illustrated in, the enclosed drawings, the present wheel is of the type which comprises a body C formed by a median disc 10, provided with a central hole 11, to be mounted to a shaft end of a vehicle, and a plurality of eccentric holes 12 for the passage of fixing bolts; and by a peripheral ring 20 configured to retain a vehicle tire. In the illustrated constructive form, the central hole 11 presents a generally cylindrical and axially innermost mounting portion 11a which is mounted around a respective shaft end of the vehicle. On the other hand, the eccentric holes 12 present an axially innermost cylindrical portion 12a to act as a guide for the body of the bolts which affix the wheel to the vehicle, and an axially outermost frusto-conical portion 12b, in which interior there is housed the conical region of the hexagonal bolt or nut operatively associated with the fastening bolt or nut of the wheel.

According to the invention, the body C is injected, in a single piece, in a polymeric composite material comprising, in a homogeneous mixture: from 40% to 70% of a thermoplastic polymeric matrix, from 30% to 60% of synthetic fibers; and from 0.01% to 10% of additives.

Preferably, the polymeric matrix is obtained in polyamide (PA) and the synthetic fibers are defined by fine flexible filaments of long glass fibers with high resistance to tension, bending and impact.

Furthermore, the preferred additives for forming the body C of the wheel are defined by compatibilization agents, aging retardants, thermal stabilizers, UV additives/absorbers, flame retardants, process aids, primary and secondary antioxidants and pigments.

Depending on the forces to which the wheel is submitted in its useful life in the vehicle, it may be convenient and even necessary to provide reinforcing elements, constructed in metallic alloy and which take the form of inserts 30, 40 positioned only in the interior of the central hole 11 or of the eccentric holes 12, or even in both the central hole 11 and eccentric holes 12, so as to impart a higher structural resistance to the parts of the body C submitted to direct contact with the shaft end of the vehicle or with the bolts for fastening the wheel to the vehicle.

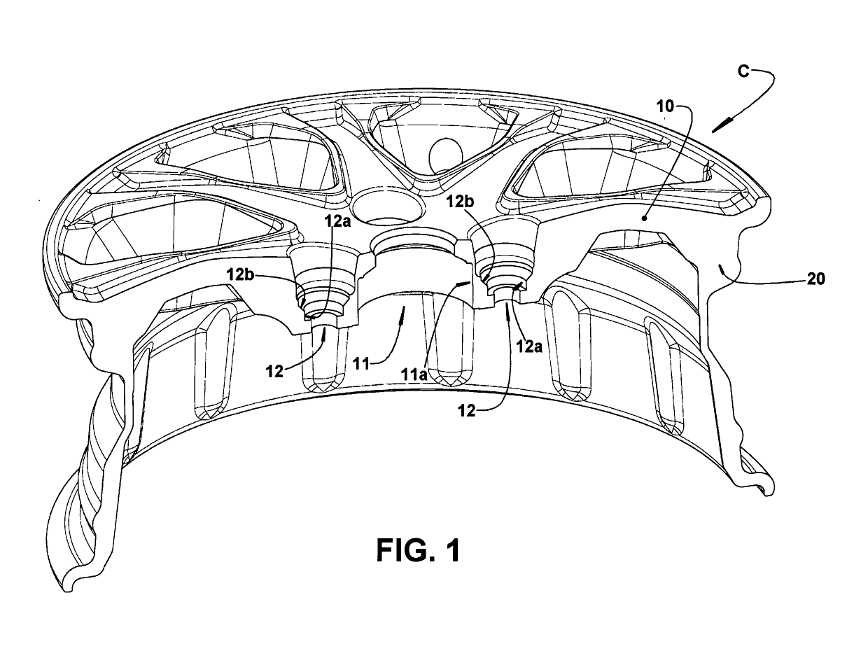

In the construction illustrated in FIG. 1, the body C is deprived of the inserts 30, 40.

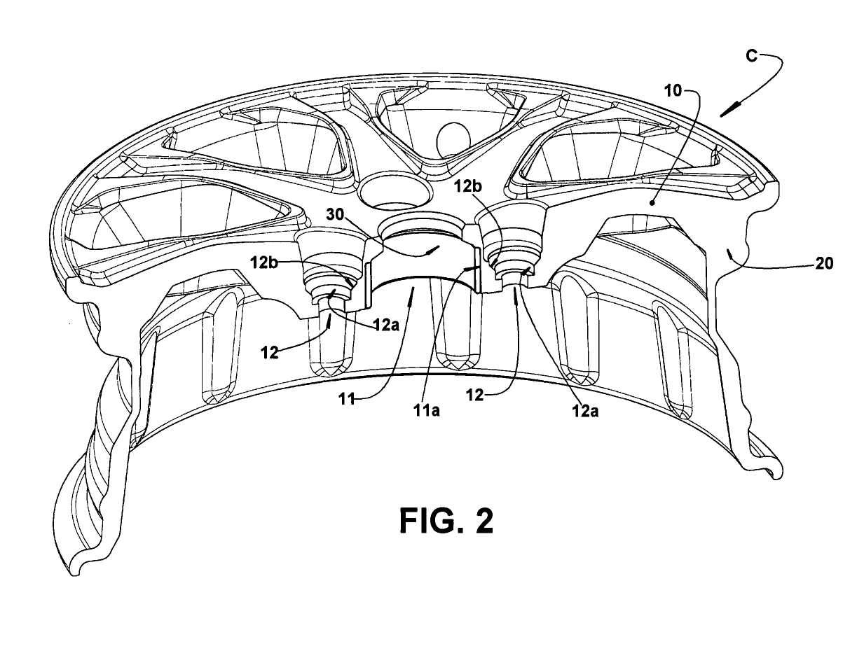

In the construction illustrated in FIG. 2, only the mounting portion 11a of the central hole 11 is internally coated by a respective insert 30. It should be understood that this insert 30 may be extended through the whole axial extension of said mounting portion 11a of the central hole 11, or only through part of said extension.

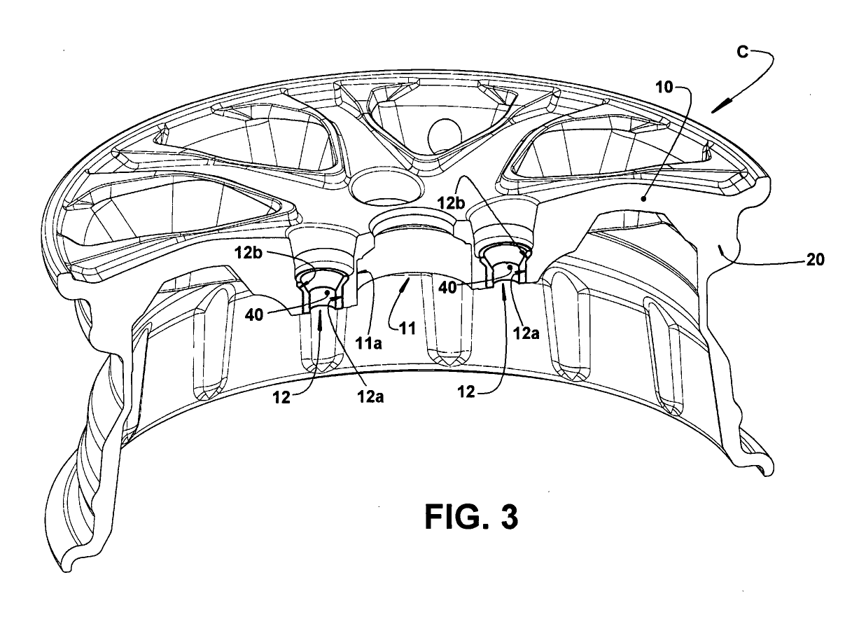

In the construction of FIG. 3, only the eccentric holes 12 are internally coated by respective tubular inserts 40. In this figure, both the cylindrical portion 12a and the frusto-conical portion 12b of each eccentric hole 12 are internally and entirely coated by a respective insert 40, whose shape accompanies the form of said eccentric hole portions.

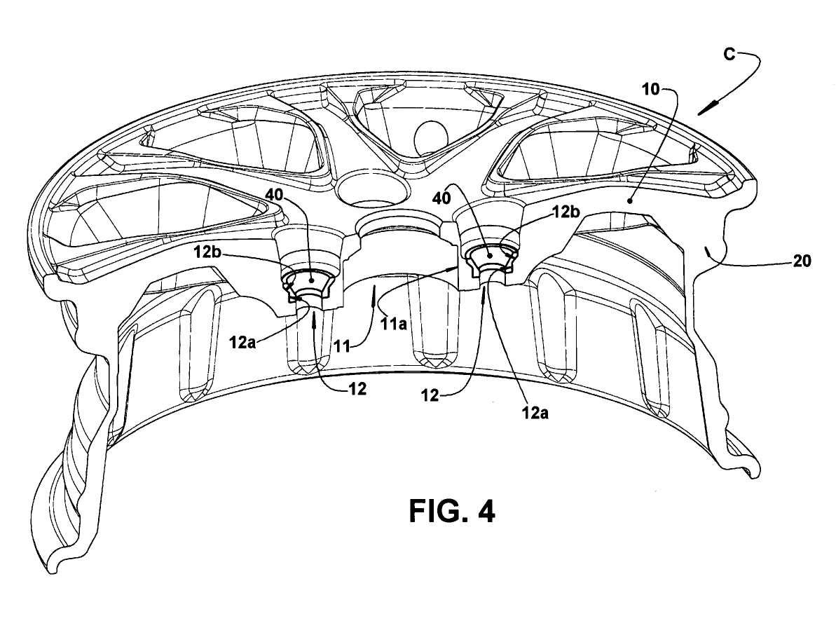

FIG. 4 illustrates a constructive variant of FIG. 3, in which the metal insert 40 internally coats the whole frusto-conical portion 12b of a respective eccentric hole 12, but only the adjacent region of the cylindrical portion 12a of said eccentric hole.

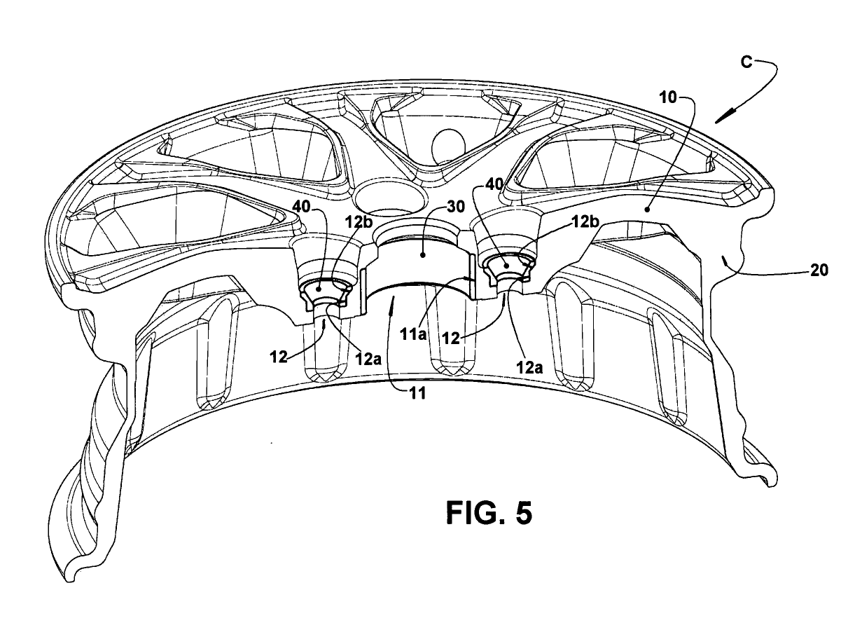

FIG. 5 represents a construction in which the central hole 11 has the entire axial extension of its mounting portion 11a coated by an insert 30, whilst the eccentric holes 12 have only part of their axial extension coated by a respective insert 40, as illustrated in FIG. 4.

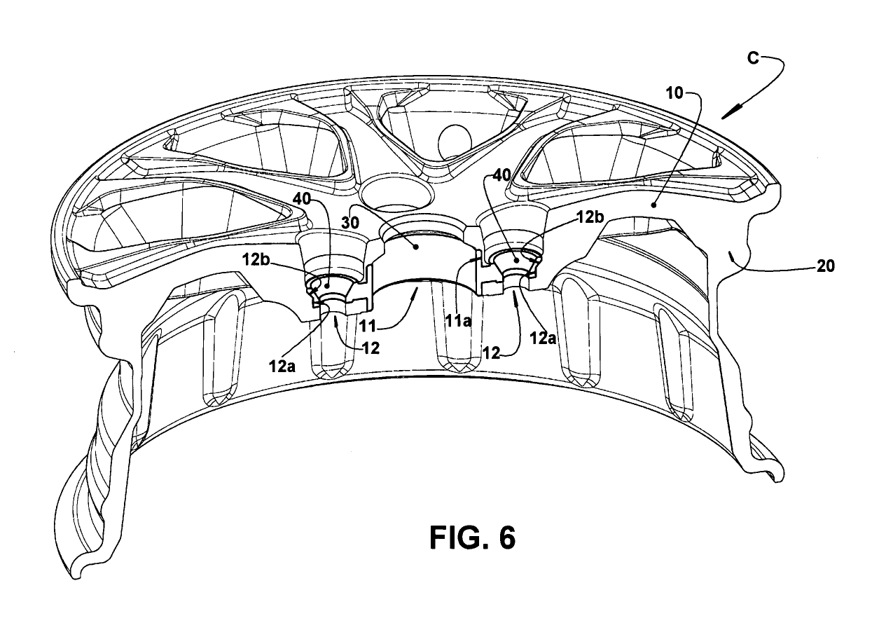

FIG. 6 represents a construction which encompasses the aspects defined in the solution of FIG. 5, but in which all the inserts 40 of the eccentric holes 12 are joined, in a single piece, to the insert 30 which coats the mounting portion 11a of the central hole 11. It should be understood that the construction of FIGS. 5 and 6 may also contemplate the use of tubular insert 40, occupying the entire axial extension of the respective eccentric holes 12.

The metallic inserts 30, 40, when applied, are over-injected, being positioned in the mold before the injection of the composite material which involves these elements and guarantees their positioning and mechanical fixation; or mounted, subsequently to the injection process, by interference through a proper device in which the force and the displacement of the insertion are monitored. The mechanical fixation is promoted by interference defined by the difference between the diameter of the hole portions 11a, 12a, 12b and the outer diameter of the metallic insert, associated with the tapering effect of the insert and of the product, which is the case of the inserts 40 of the eccentric holes 12, as well as by the configuration of a knurling applied on the outer wall of these inserts. The requirements and configuration of each product will determine which process is the most recommended for each type of insert. The construction described above allows the wheel to be produced as a single element (and not in modules to be joined posteriorly) and it can include inserts, in metallic alloy, in the mounting region to the vehicle, if necessary or required by the project, in order to prevent the tension relaxation effect which eventually can make the fixation bolts/nuts lose their torque.

The formation of said wheels is carried out by thermoplastic injection molding, which permits a higher precision, repeatability, as well as a higher productivity, allowing obtaining a single piece, with great design freedom and by using recyclable material.

Virtual analyses (virtual simulations) and physical laboratory tests, according to SAE, ISO and IBR rules, led to positive results which, in some cases, were superior to those traditionally found in wheels produced in metal alloys. The success of such results is attributed to the design and construction of the body C, combined with the correct choice of the polymeric composite which has mechanical properties, such as, for example, resistance to tension regarding yield/rupture, superior to the commonly used alloys, which imparts to the product a high absorption of energy (elastic deformation) without the occurrence of denting (plastic deformation). Moreover, there were identified reductions of weight from about 20% to 40% and 30% to 50%, as compared to the lightweight alloy wheels and steel wheels, respectively.

1-9. (canceled)

10. A wheel, comprising a body formed by a median disc having a central hole adapted for mounting to a shaft end of a vehicle, a plurality of eccentric holes adapted for passage of fixing bolts, and a peripheral ring adapter for retaining a tire, wherein said wheel is produced via single piece injection molding of a polymeric composite material which comprises a homogenous mixture of from 40% to 70% of a thermoplastic polymeric matrix, from 30% to 60% of synthetic fibers, and from 0.01% to 10% of additives.

11. The wheel of claim 10, wherein said thermoplastic polymeric matrix is a polyamide.

12. The wheel of claim 10, wherein said synthetic fibers are fine, flexible filaments of long glass fibers, and have high resistance to tension, bending, and impact.

13. The wheel of claim 10, wherein said additives comprise at least one of compartmentalization agents, age retardants, thermal stabilizers, UV absorbers, flame retardants, process aids, primary antioxidants, secondary antioxidants, and pigments.

14. The wheel of claim 10, wherein said central hole comprises an axially innermost mounting portion, and an axially outermost frusto-conical portion, wherein at least one of said central hole and eccentric holes is at least partially coated on its axial extension by a metallicalloy insert, said insert being axially and radially affixed to said median disc.

15. The wheel of claim 10, formed by injection molding said body around at least one insert.

16. The wheel of claim 10, comprising at least one insert in said central hole or median disc.

17. The wheel of claim 14, wherein only said frusto-conical portion and said adjacent region of said eccentric holes are coated by said insert.

18. The wheel of claim 14, wherein all inserts of said eccentric holes are joined in a single piece to said insert.
